(19) United States
(12) Patent Application Publication
(10) Pub. No.: US 2003/0115291 A1
(43) Pub. Date: Jun. 19, 2003

(54) Publish subscribe system

(76) Inventors: Gary David Kendall, London (GB); Christopher John Horril, Beckenham (GB); Christopher Cole, London (GB)

Correspondence Address: VIERRA MAGEN MARCUS HARMON & DENIRO LLP, 685 MARKET STREET, SUITE 540, SAN FRANCISCO, CA, 94105, US

(21) Appl. No.: 10/254,456

(22) Filed: Sep. 25, 2002

Related U.S. Application Data
(60) Provisional application No. 60/334,306, filed on Nov. 29, 2001.

(30) Foreign Application Priority Data
Sep. 28, 2001 (GB) 0123403.8

(51) Int. Cl. G06F 15/16

(52) U.S. Cl. 709/219

(57) ABSTRACT

A system of publishing data from a data repository server to a subscribing client, wherein a subscribing selector server receives data published by the data repository server, filters the published data in accordance with filtering criteria defined on the selector server, and re-publishes the filtered data to the subscribing client, and wherein the filtered data is cached on the selector server and is available for querying by the subscribing client. A number of analytical engines are provided and a broker framework receives requests for an analysis of data and selects one or more engines to use in carrying out the requested analysis. Checkpoints are used to ensure consistency of data.

### RELATED APPLICATIONS

This non-provisional application claims priority to UK Patent Application No. 0123403.8, entitled “Publish Subscribe System”, filed Sep. 28, 2001, and U.S. Provisional Patent Application Serial No. 60/334,306, entitled “Publish Subscribe System”, filed on Nov. 29, 2001, which applications are hereby fully incorporated by reference.

### FIELD OF THE INVENTION

This invention relates to a publish subscribe system, in which data is communicated over a network such as the Internet or a corporate intranet. Such systems are well known and may be used, for example, to publish financial data which can be used by financial institutions.

### BACKGROUND TO THE INVENTION

In a traditional publish subscribe system, data is published by one or more repositories, and pushed to subscribers. Typically, data is published from a repository on a number of channels. For example, one channel could relate to one type of stock and another to a different type of stock. Subscribing users must subscribe to the number of channels necessary to cover all of the data they need, but this may mean that unwanted data is received also. Users are limited by the channels provided by the repository. a further problem with traditional publish subscribe systems is that the repository database can be subjected to high loading, for example if large collections of data a retrieved or if there are ad hoc queries.

### SUMMARY OF THE INVENTION

Viewed from one aspect, the present invention provides a system of publishing data from a data repository server to a subscribing client, wherein a subscribing selector server receives data published by the data repository server, filters the published data in accordance with filtering criteria defined on the selector server, and re-publishes the filtered data to the subscribing client, and wherein the filtered data is cached on the selector server and is available for querying by the subscribing client.

In accordance with this aspect of the invention, therefore, the selector server can provide downstream applications and users with a customised selection of data which is not bound by the channels which may be provided by the data repository server. In preferred embodiments, the selector server can select data from a number of channels, and/or a number of data repository servers, and/or a number of other selector servers, filtering and combining the data to produce a customised output. In preferred embodiments, a selector server can hold a number of different filtering criteria so that it can provide a number of different channels of data.

In addition to filtering data and re-publishing it, the selector server also caches the filtered data. This means that the cached data is available to users and applications downstream. Ad hoc queries can be carried out on the cached data at the selector server, rather than on the data repository server itself. Thus, the selector server provides more efficiently selected data to users and at the same time relieves some of the load on the data repository server.

In some preferred embodiments, a plurality of data repository servers are provided, and the selector server receives data published by two or more of the data repository servers. In some embodiments, a plurality of selector servers are provided, applying different filtering criteria to the data which is re-published.

In one possible configuration, the selector server receives data which has been published by the data repository server and re-published after preliminary filtering by a preliminary selector server which caches the preliminary filtered data so that it is available for querying by the selector server.

Where a plurality of data sources such as data repository servers or other selector servers are provided, problems can arise.

In a distributed system the transfer of information can be very rapid, particularly with the publish/subscribe event model utilised in embodiments of the present invention. However, such a mechanism may present difficulties when a consistent view of data across the system is required—that is, all related data can be identified as coming from the same baseline and the contents of that baseline are known. This becomes relevant if it is necessary to identify what data has been used in a calculation, particularly where that data may have originated from various sources. It is therefore proposed to use checkpoints to provide the mechanism for such data baselining and consistency.

Data can arrive from a variety of sources such as the publishing of new trades from trade repositories, changes to static data, and variations in market data received by a market data server.

It is a requirement, when performing a calculation involving data from discrete sources (for example curve data from the MDDS and trade data from the selector server), that the data represents a known view across the system. Checkpoints provide the means to identify such a known view across the system, that is, identification of each server's state and contents in relation to a particular baseline.

Thus, viewed broadly the selector server receives data published by two or more of the data repository servers, and there is provided a checkpoint server which transmits checkpoints to each of the data repository servers at intervals, each data repository server being configured to publish a checkpoint event on receipt of a checkpoint from the checkpoint server, the receipt of a checkpoint event from one data repository server causing the selector server to queue data change events until a checkpoint event has been received from each of the data repository servers from which the selector server receives data, after which processing of the queued data change events takes place.

In addition to the primary role of checkpoints in relation to calculations they are also of relevance to auditing, reporting, and system monitoring and recovery. The checkpoint server provides the source of checkpoints within the system. It can fire checkpoint events according to any schedule (for example, every hour) or in response to direct request. A checkpoint event is passed from the checkpoint server through the system. Hence, if a server receives the same checkpoint event from all its data sources, the data must match the baseline at that point and therefore be consistent. This is true because there is a single source of checkpoint events, the checkpoint server. Checkpoints are issued via the checkpoint server to all sources of data (i.e. the repositories). This means that, subsequently, the same checkpoint is issued on all event channels from these data sources. Any server receiving checkpoints must ensure that it receives a checkpoint from all event sources prior to issuing the checkpoint on its own event channels. To achieve this there may be some queueing of events. The process of ensuring a checkpoint is received from all sources prior to its being issued, and any related queueing, can be called a “checkpoint rendezvous”.

In a preferred embodiment of a system in accordance with the invention, the selector server is capable of a cold start in which the cached filtered data is re-created from the data repository server, or a warm start in which the cached filtered data is re-created from the existing cached filter data and a history of data change events which have been published by the data repository server. The history of data change events may be held on the selector server, the data repository server or by the publish subscribe system.

Another aspect of the invention provides a data repository server for use in such a system, the data repository server being configured to publish data in a publish—subscribe system, and to publish data change events, wherein the data repository server is further configured to maintain a history of data change events and to re-transmit a set of data change events which have occurred after a specified point, in response to a request from the selector server. Another aspect of the invention provides computer software which when run on data processing means will configure the data processing means as a data repository server as described above.

Viewed from a further aspect the invention provides a selector server for use as a subscribing selector server in a system as described above, the selector server being configured to receive data published by the data repository server, to filter the data in accordance with filtering criteria defined on the selector server, to re-publish the filtered data to a subscribing client, and to cache the filtered data so that it is available for querying by the subscribing client. Another aspect of the invention provides computer software which when run on data processing means will configure the data processing means as a selector server as described.

A preferred feature of a system in accordance with the invention is a subscribing application server which receives filtered data re-published by the selector server and also receives notification of data change events from the selector server, the application server hosting an application which provides information derived from the received filtered data for transmission to a client, and wherein on notification of a data change event from the selector server, updated data in accordance with the change event is transmitted from the application server to the client. Preferably the updated data is used to change only that portion of information displayed to a user by a client user interface which is affected by the data change event.

Another aspect of the invention provides an application server for use in such a system, configured to receive filtered data re-published by the selector server and also to receive data change events re-published by the selector server, the application server hosting an application which provides information derived from the received filtered data for display to a client, and being further configured so that on notification of a data change event from the selector server, updated data in accordance with the change event is transmitted from the application server to the client. A further aspect of the invention provides computer software which when run on data processing means will configure the data processing means as an application server as described above.

A still further aspect of the invention relates to the use of data processing means to communicate with the application server in a system as described above and to access and display the information generated by the application server.

An important feature of the preferred system is the use of one or more analytics servers which provides calculation-based services to clients. These use analytics engines which provide discrete sets of calculations. A broker framework provides the core of the analytics server. The broker chooses the appropriate engine or engines for a particular job. Thus a user will make a request for a calculation on a particular piece of data, and the broker determines which engine or engines should be used. One engine may perform part of the calculation, and another the remainder. In some cases, it might be possible to use part only of the services provided by an engine. A preferred implementation is when the broker is an application server.

Viewed from another aspect of the invention there is provided a system of publishing data change events from a plurality of data repository servers to a subscribing client, wherein a subscribing selector server receives data published by the data repository servers and re-publishes the data change events to the subscribing client, and wherein there is provided a checkpoint server which transmits checkpoints to each of the data repository servers at intervals, each data repository server being configured to publish a checkpoint event on receipt of a checkpoint from the checkpoint server, the receipt of a checkpoint event from one data repository server causing the selector server to queue data change events until a corresponding checkpoint event has been received from each of the data repository servers from which the selector server receives data, after which processing of the queued data change events takes place and the data change events are re-published to the subscribing client.

Viewed from another aspect of the invention, there is provided a system for analysing data published from a data repository server to a subscribing client, wherein an analytics server provides a plurality of analytics engines which provide calculation based services to the client, there being a broker framework which receives requests for calculations on data and determines which of the analytics engines should be used for a particular request.

### BRIEF DESCRIPTION OF THE DRAWINGS

Some preferred embodiments of the invention will now be described by way of example only and with reference to the accompanying drawings, in which:

FIG. 1 is a schematic overview of one embodiment of a system in accordance with the invention;

FIG. 2 is a diagram showing how multiple repositories and selector servers can be used with multiple risk servers;

FIG. 3 is a diagram showing daisy chained selector servers over a wide area network; and

FIG. 4 is a diagram illustrating a checkpoint system.

### DETAILED DESCRIPTION OF THE INVENTION

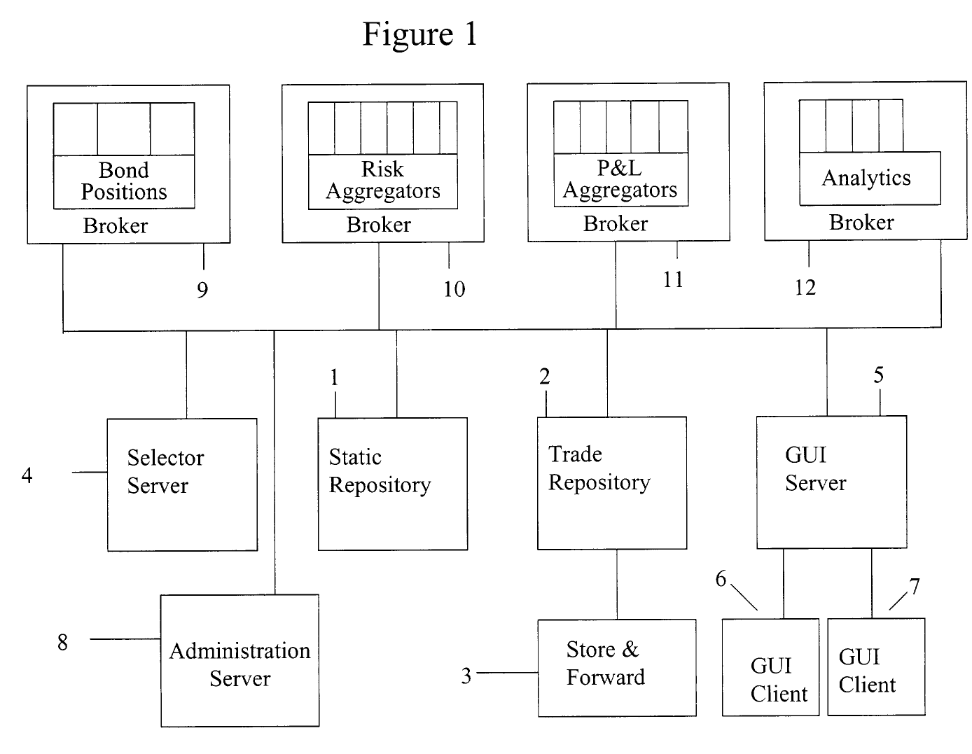

FIG. 1 shows a static or reference repository 1, a trade repository 2 with store and forward 3, and a selector server 4. A GUI server 5 is linked to GUI clients such as 6, 7. There is also an administration server 8. Four brokers are provided, namely Bond Positions 9, Risk Aggregators 10, Profit and Loss Aggregators 11, and Analytics 12.

Traditional database-centric systems based on client/server technology are 2-tier systems; these are commonly modified with a thin GUI layer and an application server behind to make a 3-tier architecture. The preferred system in accordance with the invention is neither of these; it is a genuine n-tier architecture. This means that the number of tiers in the architecture varies according to function. For example a Trade Ticker in the GUI may display information output from a Selector Server whereas a Position Grid may display information from a Position Server. The Position Server is in turn using information from the Selector Server; there is therefore an additional tier involved in the Position Grid compared to the Selector Grid. This approach allows considerable flexibility for deploying servers on machines of the appropriate power or in locations close to the end-user.

The preferred system is event driven and uses push technology to propagate events from their source to the user. Events contain information; for example details of a new trade, and this allows the system to maintain forward caches of business data which can be kept up to date with new and amended data.

Distributed Repositories store self-describing data or map onto relational database tables. Repositories can store reference (static) or trade data; the handling of entities by each repository is configurable. This means that many repositories can co-exist, each one handling a different set of data. For example there might be one repository holding swap trades, another holding exotics and a third holding bond and futures trades. For reference data there could be a single repository holding all reference data. Alternatively, for example, it can be partitioned with counterparty information in one and all the rest in another.

The Repositories are not replicated; an item of data exists in a single place. It is the Selector Server that understands which repositories hold the data; the Selector Server performs a distributed query and caches the results. Downstream processing is performed against the Selector Server. This allows trades to be partitioned horizontally so that, for example, New York based trades can be held in a New York based trade repository and London based trades held in a London trade repository. Consequently the traditional approach which involves a global master database, which subsequently becomes a performance bottleneck, is eliminated.

The preferred system uses forward caching and relies on the idea that data is pushed forwards through the components from the repositories so that local copies are available to downstream servers. The key to implementing this push paradigm is the provision of a publish/subscribe mechanism. The preferred system uses third party middleware to provide this. Forward caching is necessary to eliminate bottlenecks which destroy scalability. The system uses a protocol based on self-describing data such as XML.

The preferred system is scalable. Scalability means different things to different people but can all be reduced to three fundamental properties:

expanding the user base;

adding concurrent functionality; and

expanding volumes.

A truly scalable architecture must address all of these.

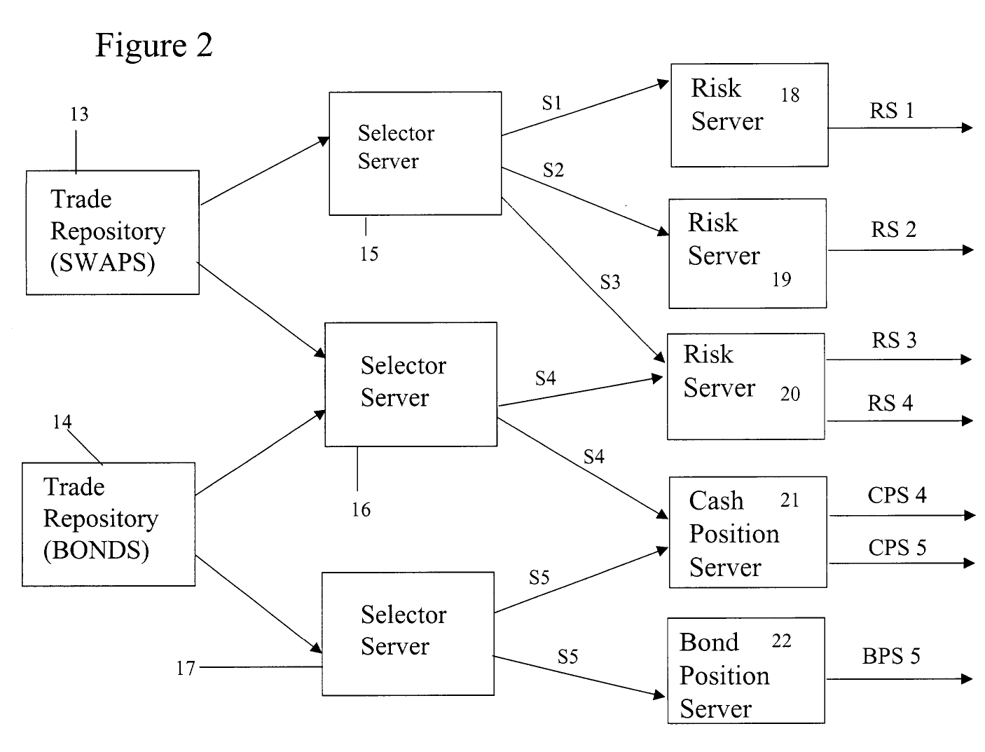

FIG. 2 shows an arrangement in which there are two trade repositories, 13 for swaps and 14 for bonds. These are in communication with three selector servers 15, 16 and 17. Selector server 15 provides data set S1 to a risk server 18, which in turn provides a feed RS1; data set S2 to a risk server 19, which in turn provides a feed RS2; and data set S3 to a risk server 20, which in turn provides a feed RS3. Selector server 16 provides data set S4 to the risk server 20, which in turn provides a feed RS4 in addition to feed RS3; and the same data set S4 to a cash position server 21, which in turn provides a feed CPS4. Selector server 17 provides data set S5 to the cash position server 21, which in turn provides a feed CPS5 in addition to feed CPS4; and the same data set S5 to a bond position server 22, which in turn provides a feed BPS5. This arrangement illustrates how the selectors partition data, how the system can be scaled up, and how forward caching is achieved.

There is the ability to expand the number of users quickly and easily without undue impact. The system is preferably written in Java which allows the user interface to run as an applet in a browser; the application code is downloaded from a WEB server at run time. This reduces the need to install software on users' workstations and consequently simplifies and speeds up the deployment. It is also possible to run the user interface as an application from a desktop icon instead of an applet.

The extensive use of publish/subscribe for data distribution means that additional client processes do not necessarily increase the load on the publishers. An additional user can either be assigned to an existing GUI Server or to a new GUI Server. In either case this need not lead to an increased load on the other servers. Each GUI server can support many clients.

The preferred system incorporates Concurrent Functionality, namely the ability to install additional concurrent processing without undue impact. The publish/subscribe mechanism allows many consumers to respond to a single published message. This enables highly parallel processing to take place. For example a new trade can cause many things to happen: printing a trade ticket on a printer, recalculating delta, recalculating cash position. The present architecture allows all these to be performed in parallel because the publish/subscribe mechanism allows a single trade event to be delivered to many downstream servers simultaneously.

The preferred system has the ability to increase trading volumes and to trade new instruments without undue impact. Distributed repositories and the selector servers are key to handling increased volumes.

The selector server partitions the data into smaller, more manageable chunks. This means that increased trade volumes do not necessarily have an impact on servers that are not affected by the additional volume. The distributed repositories mean that new instruments can be handled without affecting the existing repositories.

All components are designed so that multiple instances can be deployed, on additional machines if necessary, to handle the volume.

The system is extendable so that a customer can add functionality with no need to change the existing software. The component architecture is fundamental to this enabling this. New components can be written by customers that conform to a published IDL. The IDL is designed to accept self-describing data. The reason for this is to prevent the phenomenon known as IDL Creep whereby any change to the data passed across a CORBA interface requires an IDL change, which consequently requires a complete re-compilation of all the software. This consequence is completely incompatible with a component-based approach. The preferred system's IDL is therefore very generic.

The components can use either NOF classes to interpret the data or XML. Both formats contain self-describing data. XML is text based and has the advantage that third party XML parsers can understand it; NOFs use CORBA native types and so can be transmitted through CORBA very efficiently. Because the data is self describing, it is possible for customers to extend the data schema without the need to recompile existing components.

The preferred approach to developing analytics servers calculations is to allow customers to plug in their own analytics libraries. Java's ability to load new classes at run time (i.e. the classes did not exist when the code was compiled) is used extensively throughout the system to enable customers to extend the functionality.

The software can, for example, be written in Java (Java 2) which allows the same compiled code to execute on a number of different hardware platforms and operating systems such as Solaris 2.5/2.6 and NT4. It is possible to install the same compiled code on a mixture of the two. Although this could lead to some challenges for the systems administrators, it might be necessary where a component has to use a library of analytics functions which is only available on a particular operating system.

The GUI Client is the user interface; this is simply a presentation layer that has minimal business knowledge. It can be run as an application or an applet within a browser. The GUI Client is a signed applet. This allows it to receive callbacks from the GUI Server. The disciplines imposed by applet security are observed which means that the GUI Client does not use the local file system. All its configuration information (which includes user preferences) is downloaded from the GUI Server when a user logs in. Password verification takes place on the GUI Server too.

The GUI Server acts as a ‘gatherer’ of data on behalf of the GUI Client. It exists primarily because of applet security considerations. It also acts as a server for user configuration information. This means that users can log in from any PC and download their previous user profile which follows them. Each GUI Server can support many users and there can be many GUI Servers too.

The interface between the GUI Server and GUI Client could use the CORBA IIOP protocol. This Internet standard enables the GUI Client to communicate with the GUI Server through a firewall.

A key feature of a repository used in the preferred system is that it publishes data after committing a new or amended record. This means that downstream processes can keep their forward caches up to date on an event-driven basis. A repository stores self-describing data and is able to adapt the schema dynamically. This means that it is possible to store new items of data with an extended schema without the need to take the database down to apply a database conversion. Records with new and old schemas can co-exist in the database at the same time. The repository supports a query interface that uses cursors.

The implementation of the repository's persistence mechanism is through a pluggable Java Store interface. Implementations of this storage layer can use both an object database (ObjectStore PSE) and relational databases (Oracle, Sybase). There are two variations on the relational database mapping.

1. persisting objects in a self-describing format (such as XML); or

2. persisting objects through an object-relational mapping.

The advantage of the first approach is that it is completely flexible and does not interfere with the ability of the framework to migrate the object model at run-time. However it does not automatically take full advantage of the abilities of the relational database to index and query the data. Whereas the second approach, using the full object-relational mapping, takes more advantage of the underlying database implementation but does not allow for the same flexibility.

It is possible to provide a store implementation which provides the benefits of both approaches. The core attributes of the object model can be stored through an object-relational mapping whereas any extensions to the object model can be stored in a self-describing format.

The repository also has a mechanism that allows the state transitions to be opened up so that additional processing can be attached.

The Selector Server is fundamental to the scalability of the preferred architecture. It implements the following features:

A flexible query mechanism to extract data (typically trades) from repositories.

A forward cache of data which can be used for queries which is kept up-to-date.

A source of events to keep client queries up-to-date by republishing events.

A mechanism to perform a distributed query across multiple repositories.

A mechanism to control message forwarding (e.g. across WANs) and a protocol bridge.

A selector is a way of identifying a subset of trades. For example a selector could find:

all the trades in a particular book or set or books;

all trades against counterparties where the country of the counterparty is RUSSIA, for example;

all the swap trades that are in a done state;

all cancelled trades.

Each Selector Server is responsible for managing a collection of Selectors in a multi-threaded way. The allocation of selectors to servers is dynamic; this means that new selectors can be defined and allocated to a selector server without having to stop or restart any component. Conceptually the Selector Server can be thought of as a tagging process which works as follows.

It gets a trade that has been published from a repository and compares the trade against some selector definitions. For example all USD bond and swap trades in book BOOK7 that are in a VERIFIED state.

Where a trade matches a selector definition the server republishes the trade on an event channel corresponding to the selector's name. A server might match a trade against several selector definitions (because a hierarchy of portfolios is being modelled) in which case the trade gets republished several times.

The Selector Server also detects the situation where a trade amendment means that the trade no longer matches a selector definition. In this case it re-publishes the trade along with a tag saying that the trade has left the selector. This enables downstream servers to back-out the effect of the affected trade.

The Selector Server supports a cursor based query interface which downstream servers can use to query contents of a selector. This interface is the same as the Repository query interface; the preferred mechanism for applications to get data is to query the forward caches in the selector servers rather than to query the repositories. It also supports an interface so that downstream servers can query the selector definition.

The Selector Server is a component that matches self-describing data on the event channel against selector definitions that are also in a self-describing format. It can also be used to match static data.

When a new Selector is defined, the Selector Server has to query the trade repository to download the initial set of trades matching the selector definition. This set of trades is subsequently kept up to date by the Selector Server subscribing to the Trade Repository's event channel. The Selector Server also persists the trades that match the selector definitions. This is done for two reasons: firstly it prevents the size of the Selector Server process from getting too large. Secondly it enables the Selector Server to perform a warm start; if the server has to be restarted it retrieves the trades from its persistent store (rather than querying the Trade Repository). There is an event replay mechanism that allows the Selector Server to retrieve the trades that were published from the Trade Repository while the Selector Server was down. A cold start mechanism is also available; in this case the Selector Server reconstructs its persistent store from scratch by requerying the Trade Repository for the complete trade set. The choice of a cold or warm start is made on a command line parameter to the Selector Server, or through the configuration of an auto start mechanism.

The idea that a selector server can get its data from another selector (as well as from a repository) leads to a number of interesting and important consequences. This idea is known as daisy chaining and it enables the following:

selectors to refine selections without having to requery the repository (this is important if the repository is on the far side of a WAN);

it enables fine-grained control of data that can be forwarded over a WAN;

as part of the WAN forwarding it allows a protocol bridge between different middleware providers, for example from a broadcast to a point-to-point protocol—this can be important with WAN connections where confirmation that the data has passed over the WAN is required.

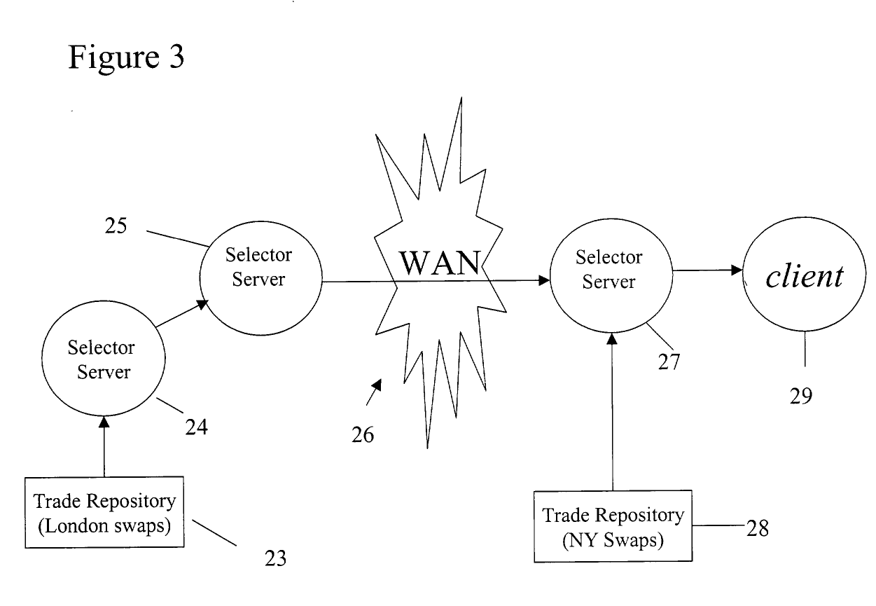

FIG. 3 shows how from a first trade repository 23 (in this case “London Swaps”) data is fed to a first selector server 24, which in turn passes data to a daisy chained second selector server 25. This in turn communicates via a wide area network 26 with a third, daisy chained, selector server 27. The third selector server 27 receives data from a second trade repository 28 (in this case “New York Swaps), and passes data to a client 29

Within the system's component architecture there are a class of applications called analytics servers. These provide calculation-based services to clients such as a GUIs or reporting engines. Examples are the P&L, Position and Risk servers. In order to generate their results analytics servers are capable of using pluggable components, analytics engines, each of which provide a discrete set of calculations (for example curve generation).

A broker framework provides the core of all analytics servers. The broker's job is to allow the various engines to play together in order that the analytics server can exhibit the expected behaviour. The broker does this by:

accepting registrations from analytics engines that are offering services within the current broker's configuration;

accepting subscriptions for data;

locating engines that can satisfy data subscriptions;

resolving any additional data dependencies for engines providing subscription data, and subscribing to this dependant data;

providing notification to subscribers when subscription data changes;

ensuring that subscription data is based on consistent source data (e.g. market data)

Analytics engines are components that advertise services to the broker. These services might be for the provision of data (market, static or trade) or for calculations. Engines register their capabilities and requirements with the broker and it is based on these capabilities and requirements alone that the broker manages its subscriptions. The broker thus has no prior knowledge of which calculations it is able to perform nor of which engines will register with it once started. Nor do individual engines require or have knowledge of one another. The engines promise to provide results to the broker. In exchange the broker promises to accept subscriptions from the engine, attempt to find other engines that can satisfy the subscriptions and provide consistent updates to the engine whenever the subscription data changes.

The analytics engines can be either in-process or out-of-process. The decision as to which configuration to use depends firstly on data volumes and secondly on issues to do with operating systems. For example an engine based on Excel Spreadsheet must run on an NT machine, but if the main analytics broker is running on a Solaris machine the Excel engine must be out-of-process. Where large volumes of data are used (for example large portfolios in a scenario) where repeated calls across CORBA would be too expensive, the engines can be used in-process to eliminate the CORBA marshalling overhead.

Out-of-process engines can be implemented in C or C++. If these languages are needed for in-process engines then this can be achieved using Java Native Interface (JNI) which enables function calls to C++ libraries. In this case it is essential that the code in the C++ library is thread safe. It is also possible to implement out-of-process engines in Excel or indeed any mechanism that allows request-response communication.

A Market Data Distribution Service (MDDS) component is the system's interface to market data. This component has four internal layers:

1. the interface to the data provider: TibCo or flat files are currently supported.

2. a layer that converts to decimal fraction format

3. a mechanism to subscribe to Bid/Ask pairs separately to calculate a Mid Price

4. a throttling mechanism which can be used to prevent (for example) yield curves from being updated at every flutter of a futures price

The MDDS can supply market data sourced from either a Data Distribution Platform such as Tibco, or from files on the computer's file system. The MDDS understands three kinds of data: scalar quantities (e.g. a money market rate), vector quantities (e.g. a curve) and matrix quantities (e.g. index volatility matrix). The MDDS understands that some prices (particularly Mid prices) aren't directly available from data feeds and can only be computed from Bid/Ask pairs. It is therefore able to subscribe to Bid and Ask values separately and to combine them to form a mid price.

The MDDS can perform some conversion operations on the data. The following list shows the conversions available:

bond prices which are quoted as fractions that have to be converted to a decimal fraction

exchange rates are quoted the wrong way round and have to be converted to the reciprocal

rates are quoted as factor of 10000, 1000, 100 or 10 times too large and have to be divided before being used

rates have to be multiplied by 2 or 5 before being used.

The market data is provided as name value pairs. In addition the MDDS provides information about the nature of the instrument i.e. whether it is a Depo, Future, Swap or Fra.

When trades are submitted to the Trade Repository they can be forwarded to another system; this could be achieved by a Trade Gateway which holds the trades in a queue. The trades would be forwarded when the other system is available to accept them.

The mechanism in the system for implementing this server is by intercepting the state transition in the Trade Repository. This enables the repository to forward the data to another server during the transaction unit. This mechanism is also used to enable the system to allocate trade ids. The reference (static) and trade repositories are implemented by the same code; the allocation of trade id's can be achieved by installing state transitions on the trade repository alone.

Repositories can be populated with data using a Bulk Loader. This reads data from a text or XML file, constructs a message and calls the repository to load the data. The format of the text file is flexible because the bulk load uses meta-data (which is another text file) to understand the data. This allows considerable flexibility in the presentation of data to the bulk loader. The Repository's publish function can be switched off during bulk load. This speeds up the loading process and also allows new databases to be constructed without affecting the network or operation of components that are subscribing to repository event channels.

A Name Service is used to establish communications between servers. A federated name space is used which allows the name space to co-exist with customers'existing names. The system achieves this by ensuring that all system Names are constructed with the first two parts of the name under user control through configuration files. The same configuration rules are applied to the construction of subject names for the event channels. This prevents name clashes with other systems and also allows parallel environments to exist. This facility is particularly useful in a test environment where several systems are required.

System management is performed from a browser interface on to each system server. This is also used to control the configuration of the whole system. A web server is embedded in the servers. The advantage of doing this is that servers will have the capability to satisfy http requests made of them. Each server responds to http request on a unique http port number. Such requests will be satisfied by the web server from one of it's available resources. Resources can include files (.html,.gif etc), directories and servlets. Servlets are the preferred mechanism for generating dynamic responses to http requests. Servlets are java classes that extend the javax.servlet.http.HttpServlet in the JSDK2.0. The servlet mechanism is intended to be a standard comparable to cgi. MSeveral servers can provide support for servlets, including Apache, Domino and Jigsaw.

The advantage of using http and XML for System Management is:

that the protocol used (http) is connectionless

the user interface can be based on a browser

the user interface is decoupled from the servers and developed/configured independently

the server side aspects are managed by servlets (which are pluggable to the web server and conform to a standard).

There is a general-purpose servlet that handles http requests for the system's components. This servlet delegates the query in the URL to the appropriate metrics class specified in the system server's property file. This class is server specific and should extend the metrics base class that also supports some common system administration requests (getProperty, setProperty, getMemory etc). This interface also allows server configuration such as the verbose and trace levels to be varied dynamically. It is also the interface that allows users to be allocated to GUI Servers, Selectors to Selector Servers, etc.

Dealing now with checkpoints, a checkpoint should be issued to each source of data for the architecture, i.e. the repositories. Each source will, subsequent to receiving the checkpoint, fire a checkpoint event on each of its event channels. The baseline for each data source can be defined by the checkpoint. Hence, the checkpoint view across data sources represents a set of consistent source baselines which can be perpetuated through the system. Issuance of a checkpoint via the Checkpoint Server will cause the checkpoint to be passed throughout the architecture.

Any server must receive a checkpoint on each of the event channels to which it listens before it can issue a checkpoint itself. This is to ensure data consistency. When a checkpoint has been received from an event channel, the processing of events on any remaining (pre-checkpointed) event channels will continue in the normal way until the checkpoint is received. Once a checkpoint has been received on an event channel, any further events received on this event channel will be placed on an event queue. The events will continue to be queued from this channel until the checkpoint has been received on all event channels. However, events received on those channels which have not yet supplied the checkpoint will continue to be processed as normal.

Once the checkpoint has been received from all event channels the checkpoint will then be forwarded by the server on each of its event channels. Any events on the queue can then be processed and the queue removed. The server will then continue to function normally until another checkpoint is received. This is termed checkpoint rendezvous. The reason for the queueing is that prior to a checkpoint being issued from a server the only data processed are those (and all those) which were issued prior to the checkpoint from any source. The checkpoint will then be issued and all data subsequently processed will have been issued by the repositories after this checkpoint. This ensures the baseline source data is maintained through the system.

Events received by a server on an event channel will be dispatched if received prior to a checkpoint but queued if received after the checkpoint. Once the server has performed the checkpoint rendezvous and dispatched the checkpoint event the queue will be processed.

A checkpoint travels through the architecture via the event channels. For this to be effective, the checkpoint must be capable of travelling on any (and every) existing event channel and not require a separate, dedicated, event channel.

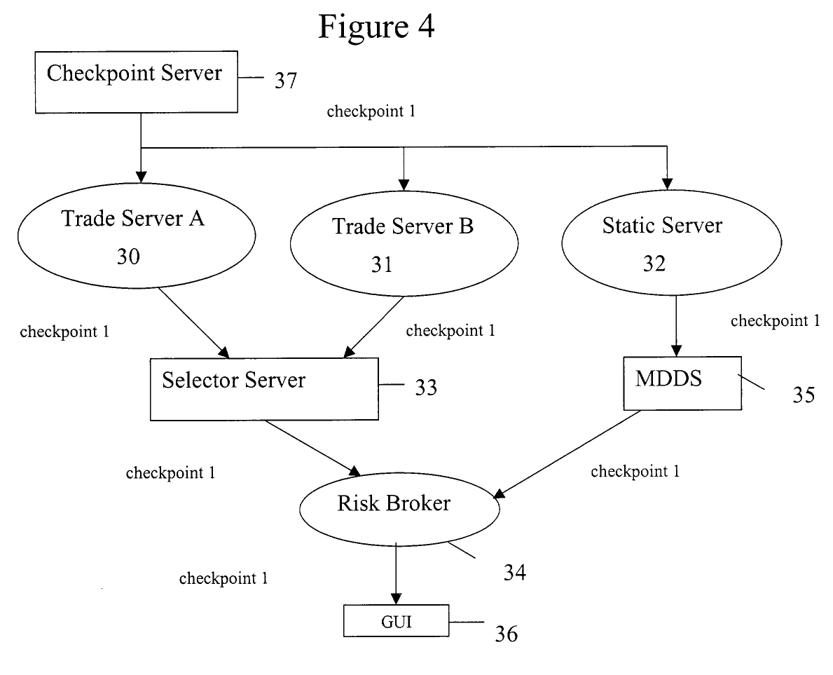

FIG. 4 illustrates the checkpoint system. Trade Server A 30 and Trade Server B 31 are shown, together with a Static Server 32. Trade Severs A and B feed a Selector Server 33 which in turn feeds a Risk Broker 34. The Static Server 32 feeds a Market Data Distribution Service (MDDS) component 35 which also feeds the Risk Broker 34. The Risk Broker provides output to a GUI 36. A Checkpoint Server 37 is provided which issues checkpoints. In this case a “checkpoint 1” has been issued.

Assume that the sequence of events from Trade Server A to the Selector Server is as follows: T1, T4, checkpoint 1, T5, T6. Assume that the sequence of events from Trade Server A is T2, T3, T7, checkpoint 1, T8. The Selector Server queues T5 and T6 until there is a checkpoint rendezvous. Thus, the sequence of events leaving the Selector Server is T1, T2, T3, T4, T7, checkpoint 1 (after the rendezvous), T5 (from the queue), T6 (from the queue), T8.

A checkpoint is a Nof and hence is a self-describing data structure. Information is held on each checkpoint to identify it, for example, time/date issued or source. A server receiving an event can inspect the event to see if it contains a checkpoint Nof and, if so, handle it accordingly. Thus the use of checkpoints is dynamic and fits well with the event model.

There are two strategies by which a checkpoint could be handled in the broker architecture.

The first is the checkpoint rendezvous. In this the system ensures that a checkpoint is received from all event sources, (queue events until this is true), then calls for all components in the broker to calculate. All calculations are then derived from the baseline data, and have a consistency based on that. However, this may cause a ‘calculation storm’ where all engines are called to calculate within a small time scale (creating a large impact on resources).

In the second way the checkpoint is handled on event channels as any other event and therefore is subject to the broker rendezvous rather than the checkpoint rendezvous (broker rendezvous is the outcome of successful completion of dependent actions within the broker).

Broker engines may differ in their response to a checkpoint. It is possible to have a checkpoint-specific response from engines.

An engine may normally recalculate in response to a data update (for example a fast pricing engine that is called to recalculate in response to the majority of data updates) but may simple report its last calculation in response to a checkpoint.

Another engine may not normally initiate a calculation in response to a data update (for example an lengthy calculation only required for a minority of data) but may carry out a full calculation in response to a checkpoint.

The output of these two engines would be subject to broker rendezvous on the checkpoint event and a client update issued.

If there are two engines within the broker framework that exhibit different behaviour in response to a checkpoint, the fast engine may report the result of its last calculation, whereas the slow engine initiates a calculation. The outcome of the two engines are rendezvoused and the checkpoint is issued from the broker.

Checkpoints of different descriptions may be associated with different roles or responses. A checkpoint nof can contain any amount of information and some of this may be used to determine a different role for a checkpoint. For example, a checkpoint could be associated with a ‘source’. This could be something very general (e.g. system) or something more specific (e.g. report, book 1).

Checkpoints associated with different sources are passed around the system by the same mechanism and on the same event channels.

A particular server or engine in the broker may respond to the different sources of checkpoint in a different way (that is, determination of response according to checkpoint source). An example is a broker which has two subscriptions, one from a manager and one from a trader. The manager subscribes to all data available in the broker and is only interested in occasional reports about all the data, but not changes in the data as they happen. The trader subscribes to a subset of the available data (e.g. that associated with Book1) but requires to be as up to date with changes in the data as possible. In this example the trader's subscription is a subset of the manager's. Checkpoints received may be associated with one of two sources, Book1 and All. If a checkpoint arrives from source Book1 then broker rendezvous is only achieved for the trader who receives an update. However if a checkpoint is received from source All then broker rendezvous would be achieved for the manager and the trader, both of whom would receive an update. This would be a normal update for the trader but perhaps an end of day report for the manager.

Assume that there are two sources of checkpoints. A Trader listens to a subset of trades in the broker. He will receive an update in response to checkpoints targeting this subset, or checkpoints encompassing all the trades in the broker. The Manager however will only receive an occasional update in response to a checkpoint affecting the whole broker.

The individual engines may also show different responses to different sources of checkpoint. A pricer may perform a calculation in response to a checkpoint of source BOOK1 but reuse the last update and, in addition, report on its status, in response to source ALL (similar to the description above but using source of checkpoint rather than the fact that an event is a checkpoint as the deciding factor).

The cost of inter-process communication may make it prohibitive to perform full out-of-process rendezvous unless the compute time approaches or exceeds the inter-process communication overheads.

There are two approaches to ensure consistency where the portfolio is too large to be calculated in a single broker. The first is for the portfolio to be partitioned such that there are no dependencies between data on different brokers. This results in an efficient implementation because no inter-process rendezvous is required. Results from several such brokers can be passed to a super broker which performs a second level of aggregation. The second is for the dependencies to be modelled between brokers by the use of checkpoints. Checkpoints are propagated to every broker and allow events to be initiated in the broker with a special checkpoint tag. This allows a super broker to perform rendezvous across data arriving from several broker processes. The cost to the user of this consistency is that some readily available results may be delayed whilst other calculations are still being processed. In most cases this means that any new request can be produced immediately from the previous consistent set of data.

Checkpoints also enable to broker to simulate batch behaviour. For example, a special checkpoint can be used to trigger the end of day processing. Because the brokers already have a complete up-to-date set of the trades, market data and reference data the results can be generated much faster than would otherwise be possible.

The optimum performance will always be gained by separating the dependencies across processes. If this cannot be achieved then checkpoints can be used to maintain consistency. In deployment, a balance can be achieved by separating out as many dependencies as possible across processes. Checkpoints can then be reserved for the remaining dependencies.

Checkpoints are also relevant for system monitoring, audit, reporting and recording the system state. These areas can be addressed with server specific methods to handle a checkpoint.

There are certain WAN implications. Differing strategies might be used for the issuance of checkpoints from different sources by the checkpoint server. One possible strategy might be the throttling of checkpoints from different sources independently at different rates. For example, a ‘system’ checkpoint is issued every hour but a ‘report’ checkpoint is issued only once a day.

It might be preferable for all checkpoints to be issued by the same throttler, but each tenth checkpoint issued will be of source ‘report’ whereas all others are of source ‘system’. This is related to the introduction of major and minor checkpoints, where a major checkpoint is issued rarely but requires more work to be done in response. The minor checkpoint is issued more frequently but minimal response is required on receipt of it by the majority of servers.

Dealing now with the broker framework in more detail, the Broker is a container application into which java classes that implement business functionality can be loaded. These classes are called engines. The broker manages the invocation of the engines and marshals the input and output data in their behalf. The broker allows engines to be chained together at run time so that the output of one can be passed as the input to the next. The broker understands the dependencies between the engines and, because of this, is able to ensure that a minimal number of engines are invoked in order to execute a calculation.

This concept can be illustrated in the context of a pricing algorithm. A pricing algorithm (whether its a simple price to yield or a complex swap npv) can be decomposed into a set of inter-related functions with the outputs from one or more functions serving as inputs to others. If the algorithm were implemented in a spreadsheet some cells would contains static data and some would contain functions. The functions would take references to cells containing static data or cells containing other functions as their input. When the value in a cell is changed the spreadsheet recalculates the values in cells that reference the original cell. The process continues until there are no more dependent cells to recalculate.

The broker implements a dependency machine. This is a reusable component that is independent of the implementation of the engines; it operates on the engines according to the data dependencies that the engine has declared.

The broker is a highly scalable and adaptable component which can be deployed in both multi-threaded and multi-process configurations. Because the separation roles between the engines and the broker has been so well established it has been possible to deploy the broker in many differing applications. Here is a list of some typical broker deployments:

a risk server operating on large multi-currency portfolios of cross-product instruments where deltas and greeks are recalculated in real-time according to market data movements

a bond analytics service providing bond pricing using embedded C++ libraries

a Position Server for maintaining real-time trading positions. The brokers embedded aggregator and drill down service enables flexible, real-time slice-and-dice analysis of positions

a Matrix Pricing Service where instrument prices are spread over other instrument prices which in turn are spread over others

a trade capture validation service where field-by-field validation and form-based validation is required based on business rules implemented in engines.

The idea of a subscription is fundamental to the broker and needs a little explanation. It originates from the publish/subscribe world of messaging where a consumer of information can subscribe to a subject; the consumer has no knowledge of where the data comes from and some intermediate middleware maps the consumer's subject to an appropriate data source. The act of subscription means that the consumer receives callbacks containing the results (and subsequent changes to the results) until the consumer unsubscribes.

The broker extends this concept idea by:

making the subject of the subscription an object with arbitrary attributes (rather than simply a string)

by allowing the subscriber to pass additional information with the subscription that qualifies or modifies the nature of the subscription allowing the subscriber to specify the nature of the data returned in the callbacks.

These three parts of the subscription are called the instrument, context and result set respectively.

The system has a sophisticated mechanism for passing self describing data objects called Nofs.

The instrument is the object on which the engine operates. The data type used for the instrument is a Nof. The word instrument is possibly misleading because it carries connotations of tradable instruments. Examples of things that can be passed as the instrument include:

reference to a security because we want to perform a price/yield calculation on that security

reference to a swap trade because we want to get its npv

reference to a curve because we need to generate a set of discount factors for a yield curve

a selector name because we want to get the delta for a portfolio of trades.

The instrument is usually a object that has been persisted in a repository. However this does not have to be the case. The object identity (oid) on the instrument can be zero—meaning that the instrument has not yet been persisted in a repository as would be the case if a trade capture validation service is being implemented.

Finally it should be noted that the instrument does not even have to have an existing metadata definition. This is an extremely flexible feature that allows a subscriptions on a completely arbitrary instrument.

The context allows a subscriber to supply additional information to the engine. The data type used is an array of NofAttributes. Examples of why an engine might need additional information include:

a security price—as the input to a price to yield calculation

an as of date—pricing is always date sensitive

a string literal indicating a curve generation methodology—because the trader wants to run a particular scenario against the portfolio.

A piece of context information will often be simply an attribute name followed by a value (being a string, int or double). However a NofAttribute can also contain Nofs and NofItems; this means that complex data structures can be passed as context information. Remember also that NofAttributes can contain arrays—so its possible to pass lists of information on the context.

It is often the case that an engine requires several pieces of context information. For example a engine calculating the npv of a swap trade might need both an as of date and a curve generation methodology.

The result set is the most self explanatory part of the subscription. The data type is a NofAttribute. Similar considerations apply as with the context which means that the result could be either a primitive data type (e.g. a double) of a collection of things (e.g. a delta and some greeks) or an array of things (e.g. the npv for each trade in a portfolio). This flexibility is possible because the NofAttribute can contain self describing data. The result set also supports the concept of suspect data; this is discussed in more detail later.

There are several kinds of engine that can be deployed in a broker. Possible kinds include stateless and stateful engines. There are others too which are introduced later in this document. Most engine implementations use the stateless and stateful paradigms and these are discussed first.

An engine is simply a java class that implements an interface. The Engine interface requires the implementation of three (main) methods: mappings( ), subscriptionMapping( ) and calculates( ).

The broker uses java dynamic class loading to create an instance of each engine that appears in its configuration. The default constructor is called at this stage. At this stage the broker creates one instance of each engine and calls the mapping method on it.

Mapping is where is where a programmer declares what the engine needs in order to do its job. It is a little like the declaration of a method in that it defines the data requirements in terms of types, but it does not actually operate on a concrete object. There is usually no need to do anything else in the mapping method other than returning the mapping information to the broker.

The broker understands the engine's data requirements (i.e. its dependencies) from information supplied in the mapping. Consequently it is important to understand how to construct the mapping and the ideas of instrument, context and result set introduced above before proceeding. It is important to understand that in the mapping the context information declared in an array of Strings (not an array of NofAttributes); the reason being that the broker is only interested in the name part of the NofAttribute (which is a name+value pair) at this stage.

Note that the broker will only give information declared here. If a null context is specified in the mapping then the broker will supply a null context (even though the user might have supplied lots of context information on the subscription) when the time come to invoke the calculation.

One example would be an engine that performs price to yield calculations. It can operate on an instrument defined in the LBOM as a Bond, it requires a price and an asOfDate and returns a yield. Another example would be an engine that does not require context, such as an engine that calculates accrued interest for a bond, there being no context because it is assumed that the date is obtained elsewhere.

Note though that an engine can declare multiple mappings e.g.

| Example | Instrument | Context | ResultSet |
|---|---|---|---|
| 1 | Bond | null | yield |
| 2 | Bond Benchmark | Bond | yield |

Many problems can be decomposed into several steps each of which are suitable for implementation as an engine. The broker allows engines to make subscriptions to other engines and the subscriptionMapping method is the place that enables this. The advantage of decomposing a problem into smaller parts becomes really apparent when considering how the broker manages events when it comes to calculating the results. The broker understands the data dependencies of each engine and is able to make sure that the minimal number of engines get invoked to calculate a result.

Here is an example: consider a portfolio of two vanilla swap trades that are both priced off the same USD curve. This problem lends itself to being decomposed into two engines: a curve generator which calculates the USD zero curve and a swap pricer that can price a swap given a trade and a curve as input. When the broker comes to calculate the result it runs the curve generator once and passes its output to both swap pricers,

An engine makes a subscription to another engine in a similar way to a client application subscribing to the broker. It makes the subscription by specifying an instrument, context and result set. The broker searches to find a suitable engine that matches the subscription. An engine is able to make more than one additional subscription; this is possible because the subscriptionMapping( ) actually returns an array of subscription objects.

The broker passes an Identity object into the subscriptionMapping; the Identity can be used to retrieve information about the subscription including the instrument and context. This should provide sufficient information for all decisions to be made about further subscriptions. For example, in our swap pricer scenario outlined above, the instrument obtained from the Identity would be a swap trade which would (presumably) have information about the trade's currency (USD) and index (LIBOR) so that a subscription to the appropriate curve can be made.

An engine can use this technique to establish dependencies on two or more other engines. In this situation the engine will receive callbacks when the data from any of the dependent engines changes unless the dependent engines are themselves dependent on the same source events.

One example could be where engine 1 is calculating the value of a cap that is dependent on the underlying zero curve which comes from engine 2 and a volatility surface from engine 3. The curve and the volatility are fed from independent market data source (i.e. the two quantities vary independently).

Another example could be a single source event where engine 1 is calculating the npv for a portfolio of two swap trades, both of these are USD LIBOR which means that they are both dependent on the same zero curve generated by engine 4. In this case the broker invokes an important mechanism known as the rendezvous which ensures that engine 1 only gets called-back once with a consistent set of input data from engines 2 and 3.

The broker uses a callback method on the engines called calculate( ). This method takes a single parameter called the event. The identity can be thought of as a container object for all the information required in the callback:

the context information (which contains the results from other engines via the subscriptionMapping)

the instrument

the result set names

The broker calls calculate( ) when all the data requirements of the engine have been fulfilled. An engine with a null context is a special case where the data requirements are fulfilled immediately; in this case the broker generates an event object and invokes the calculate( ) method.

The broker invokes calculate( ) in response to an event (events are discussed in more detail later). The calculate method must finish: either normally by returning a result set to the broker or abnormally by returning suspect data to the broker. The event is always passed back to the broker. Suspect data can be indicated on the event by using the method setSuspectData( ) and returning null.

The broker maintains a threading policy that frees the developer from having to worry about thread management. However there are situations where the developer of an engine will want to have some control over the threading policy:

when the time taken to complete a calculation is long (for example 10 ms or more could constitute a long time)

when an engine generates events on which many other engines instances are dependent.

For example a risk analysis in a multi-currency portfolio might lend itself to having its curve generator (there might only be 30 currencies) working on a thread. This means that all the dependent trade pricing engines would run on the same thread.

The suggested design approach for engines is to disregard the threading policy initially, to get the engine interfaces correct from a functional point of view and to build a first pass implementation. The use of threads should be a second-pass activity.

The next section explains how the broker chooses the most appropriate engine to satisfy a request. Firstly the broker searches for engines that operate on the correct instrument (including engines that operate on a superclass) and that supply the required result set. It then attempts to maximize the use of context information—in other words it tries to find an engine that will use as much of the context information supplied on the request as possible.

This is best clarified with a short example: consider two engines that operate on the same instrument and result set—the only difference between them is that one requires only one piece of context information (lets call it alpha) and the other requires two (called alpha and beta). A user request that supplies alpha and beta on the context will be routed to the second engine; a user that supplies only alpha will be routed to the first engine. A user that supplies alpha, beta and gamma will be routed to the second engine.

A more interesting example happens when there is an engine that requires alpha and beta on the context but the user only supplies alpha; in this case the broker will search for another way of getting the missing information namely beta. If it finds an engine that generates beta as a result then it will combine that engines output with the users context as the input to the engine.

The discussion so far has centered around stateless engines. These are the basic paradigm that the broker supports. It should be clear that there is a distinction between the number of engine objects, instances and subscriptions. With the stateless engine there might be only one object but many instances. There is an instance for each distinct result held in the broker: if there are 100 trades in a portfolio, each one has its npv so there would be 100 distinct results or instances. You might then have 10 users each looking at the npv for these trades; in this case there would be 10 subscriptions to each trade giving a total of 1000 subscriptions in total.

The broker implements extremely efficient memory management and reuse in the case of stateless engines.

It is not always possible to implement a solution using stateless engines. Here are some examples of where the stateless engine model breaks down:

An engine that receives callbacks from two or more engines that are not dependent on the same event source and where its important (for the purposes of doing the calculation) to figure out which dependent engine has changed value.

In this case the engine needs to hold the last known input values on instance variables and compare the current input with the last input. The calculation is genuinely stateful; for example some volatility calculations are based on rolling averages of the last n inputs. In this case the engine would hold the last n values on an instance variable.

The calculation takes a long time to compute and need not be performed if the input values have changed within a tolerance value. In this case the previous input value needs to be stored in an instance variable.

From a programmer's point of view the stateful engine is identical to the stateless engine except that the stateful engine requires an additional cleanup( ) method to be implemented. The cleanup( ) should be used to free or release resources that have been allocated by the stateful engine; the broker will invoke the cleanup( ) when the engine is unsubscribed. Failure to correctly implement cleanup( ) can result in resource or memory leaks in the application,

The engines considered up to this point have a callback that is invoked by the broker; an event is passed to the calculates and the engine returns the (modified) event back to the broker which passes the event on to the next engine and so on. This conveniently overlooks the question as to where the event originates from in the first place.

Events originate from Event Source Engines. A number of event source engines can be made available.

An event source engine must implement two constructors: the default constructor which is used to load the class (just as in the stateless engine) and a constructor that takes an EventSourceComponent object. The engine must hold the reference to the EventSourceComponent because it will be used later to send new events to the broker. The Event Source Engine is therefore also a stateful engine and it therefore must also supply a cleanup( ) implementation too.

A Transactional Engine allows business logic to be applied to objects received from a selector in a transactional way. The incoming event is persisted in the brokers local persistent storage and only when the transactional engine has completed processing the event will the broker remove the event from the persistent storage. Note that one or more transactional engines can participate in this scheme.

This paradigm is particularly useful when the business logic in the engine is managing workflow.

A data source engine can be used to obtain a stream of events as data in a selector or repository changes. The engine uses the client services data sources. The consequence of this is that a selector is the primary source for the data; if there's no selector present then the data is obtained from a repository instead.

The way to use the data source engine is to construct a subscription where:

instrument is a nof containing a nof item which has two attribute:

name which is the selector name or Ibom type that is required filter which contains an nql statement used for filtering the results. context is null

result set is dataChangeEvent

A reference data factory provides a service in the broker which provides a broker cache for reference data. The service it provides is similar to the RepositoryClient but differs in two important respects:

it gets its initial set of data by querying a selector which means that a large cache can be initialised very quickly and

it provides a notification mechanism using the broker calculates callback( ).

The selector used for the reference data is configured in the broker's domain using a property which specifies a space separated list of selectors to be installed on startup of the broker. These are only queried or available through the utilities if the broker is configured to use a reference data factory. The reference data factory has a strategy for resolving requests when the data is not present in the selector; it will obtain the data from a repository instead. The source of the data is completely transparent to the subscriber.

An API is provided that simplifies

making a subscription to the ReferenceDataFactory

retrieving reference data from the event during the calculates method.

An aggregator is an engine specifically designed to view results produced by engines across a portfolio of data. It borrows from OLAP concepts to provide a view on the data that is personalised for each user of the system while still allowing users to share the underlying results produced by the engines.

To write an engine to work with the aggregator it is necessary for it to produce the results in the form of dimensions and measures. Each measure is a calculated value, such as position or NPV, which can be aggregated simply by summing the outputs across several engines. For example the NPV of a book can be calculated as the sum of the NPV of the trades in the book. In order for this aggregation to be personalised into different views, the engine has to specify the dimensions for each measure that is produced.

The dimensions are the discrete attributes by which the aggregation can then take place, for example the book, currency or instrument of a trade. Each aggregator-compatible engine should provide all of the dimensions that are available to it so that it is possible for them to be used in a particular aggregation.

Time is a special dimension that the aggregator has to handle in a different way. The aggregator allows a measure to be specified to occur on a particular day. However, because time is continuous, the aggregator also assumes that the measure retains the same value over time unless told otherwise. For example if a RepoTrade is open for one month, the bond position measure of the trade would only have to be present at two points in time: when the repo opens and when it closes. The aggregator would interpolate the intermediate dates.

The default threading model of the broker (when setting up subscriptions for the Aggregator, which is the big issue here) is to allocate one thread per 100 objects queued up (from the selector). This is up to a maximum of 10 threads. Similarly the cursor batches from the selector are sized at 100. These figures can be configured but have been chosen carefully to have sensible default values.

In a normal engine (i.e. one that does not implement the IndexingEngine interface) then two different but overlapping user subscriptions will be mapped to two instances of an engine, even if the engine is required to do the same work. An indexing engine can override this behaviour by giving you the ability to change the context of a subscription—either by adding or (more usually) removing context attributes or by changing the values of context attributes. The effect of this is to map the subscription to an existing engine instance.

It is possible for an engine to refuse to accept a subscription. This is achieved by throwing an AnalyticsException in the subscriptionMapping( ) method. That explains how to veto a subscription, but why would an engine want to do such a thing? Here are a few examples where vetoing has been used.

Bond yields are usually calculated from prices (the prices are quoted in the market). An engine can be provided that operates on a security (the instrument), the result set is a yield and the context contains the price. However some bonds have yield quoted in the market rather than price—for these bonds there is no need to calculate a value. There are a number of ways of setting up this problem using engines.

One way is to set up two engines: one whose result set is called marketyield and another whose result set is called calculatedyield. The onus is now placed on the subscriber to select the correct engine by forming their subscription appropriately; in other words the subscriber needs to know which bonds are quoted by price and which are quoted by yield.

Another way of achieving this is to install two engines both of which produce a result called yield. One of them is an event generating engine and provides yields from a data feed; the other is a conventional engine (stateless or stateful) that calculates yield from price and the price in turn is provided from an event generating engine that gets prices from a data feed. The first engine's subscription mapping contains code that looks up the instrument code in some database that tells us whether the yield is available on a data feed. If the yield is not available then an AnalyticsException is thrown; the result of this is that the broker will search for another engine that provides yields. The benefit of this approach is that all the knowledge about whether the yield is available from a data feed is entirely encapsulated in the engine that implements the interface to the data feed. The subscriber simply asks for a yield and does not care where is actually comes from. There is one final twist to this example: how do you make sure that the broker chooses the data feed yield engine as the first preference and only tries to use the other engine as a second choice? This is achieved by putting an extra piece of context information on the data feed engine and making sure that the subscriber also puts that context on their subscription. The context is interesting because it can be called anything you like (e.g. “first_preference”) and the value the subscriber supplies is never actually used. The brokerwill now identify the data feed yield engine as the best match to the subscriber.

The subscriptionMapping can be used to implement user authentication and permissioning based on information available in the context. If the some required information is missing (which would normally indicate that the user has successfully logged in) then the engine vetoes the subscription. This is an effective mechanism for performing user or group permissioning in the engine.

The subscriptionMapping can be used to ensure that different pricing model versions are used for different trade versions; if the trade's data is incompatible with the version of the pricing algorithm then the engine can veto the subscription and the broker will search for an engine that will accept the subscription. In this case there might not be any need for the preference mechanism described in the data feed yield engine above.

The subscriptionMapping can be used to ensure that subscriptions are only accepted if there are sufficient resources to process it; if its known that the subscription would take too long, use up too much memory or make use of some other resource that is in short supply then the engine could veto the subscription.

To apply updates to a repository within a transactional engine requires use of the client services API. On startup, a broker will instantiate each of it's engines. Every engine that needs to use client services will be required to individually login.

Each engine will instantiate the appropriate class as part of its initialisation.

Seeding is the ability to install a subscriber inside the broker's JVM; this means that subscriptions can be automatically applied to a broker when it starts. This feature can be used to warm-up the broker by applying commonly used subscriptions when the broker is started. This can be done in the early hours of the morning so that broker responds promptly to users applying their subscriptions at the start of the trading day.

Seeded subscriptions are best used for subscriptions that are timeinvariant; subscriptions to reference and selector based data are good examples of time invariant subscriptions. An example of a time dependent subscription would be where the asOfDate appears on the context supplied by the subscriber—this is a bad candidate for seeding because the required subscription changes from day to day.

Most objects used as the instrument in an engine will have associated data (this is sometimes called reference data). In some applications the ratio of reference data to the subscription instruments is high (for example a portfolio of 10,000 interest rate swaps will only be against a maximum of 50 different currencies); in this situation there is no problem with getting the reference data into the broker using the RepositoryClient (because the total time taken to query 50 distinct objects one at a time is small). Where the RepositoryClient is used to obtain reference data the following points should be noted as regards performance:

The size of the NofCache under the RepositoryClient is crucial—if it is too small then the least recently used objects get expelled from the cache. When this happens you should consider resizing the cache using the nofcache.size configuration parameter—the default value is 1000.

The NofDescriber uses the RepositoryClient under the covers—do not make excessive use of NofDescriber.

The RepositoryClient does not inform your engine when the reference data changes.

However there are some applications where the ratio is closer to 1:1 (for example a large portfolio of bond trades where say 100,000 trades are against 50,000 different instruments). In this case the time taken to obtain the reference data (one at a time) becomes prohibitively high.

A better approach is to keep the reference data in a selector and to use the Instrument Subscription Engine. Queries against the complete contents of a selector can be performed very quickly and are performed by the Instrument Subscription Engine when the broker is started up (the broker detects the presence of this special engine and waits for it to finish loading the selector data before it completes initialisation). The reason that this performs better is because the bulk transfer of reference data can be done quickly; consequently the broker has been pre-populated with the reference data and it can be supplied to the engine on each callback.

Computer software for use in the various aspects of the invention may be supplied on a physical data carrier such as a disk or tape, and typically can be supplied on a compact disk (CD). The software could also be supplied from a remote location by a communications network, using wire, fibre optic cable, radio waves or any other way of transmitting data from one location to another. The software will comprise machine readable code which will configure data processing apparatus to operate in accordance with the systems in accordance with the invention. The data processing apparatus itself will comprise volatile and non-volatile memory, a microprocessor, and input and output devices such as a mouse/keyboard and a monitor. A network connection device will also be provided.

References in the description or claims to particular servers or other components do not imply that these components are necessarily single components. A server could be constituted by two or more physical machines, for example.

While the present invention has been described in terms of the above embodiments, those skilled in the art will recognize that the invention is not limited to the embodiments described. The present invention can be practiced with modification and alteration within the spirit and scope of the appended claims. The description is thus to be regarded as illustrative instead of restrictive on the present invention.

What is claimed is:

1. A system of publishing data from a data repository server to a subscribing client, wherein a subscribing selector server receives data published by the data repository server, filters the published data in accordance with filtering criteria defined on the selector server, and re-publishes the filtered data to the subscribing client, and wherein the filtered data is cached on the selector server and is available for querying by the subscribing client.

2. A system as claimed in claim 1, wherein a plurality of data repository servers are provided, and the selector server receives data published by two or more of the data repository servers.

3. A system as claimed in claim 1, wherein a plurality of selector servers are provided, applying different filtering criteria to the data which is re-published.

4. A system as claimed in claim 1, wherein the selector server receives data which has been published by the data repository server and re-published after preliminary filtering by a preliminary selector server which caches the preliminary filtered data so that it is available for querying by the selector server.

5. A system as claimed in claim 1, wherein the selector server defines a plurality of filtering criteria and re-publishes differently filtered data on a corresponding plurality of channels.

6. A system as claimed in claim 1, wherein a plurality of data repository servers are provided, the selector server receives data published by two or more of the data repository servers, and wherein there is provided a checkpoint server which transmits checkpoints to each of the data repository servers at intervals, each data repository server being configured to publish a checkpoint event on receipt of a checkpoint from the checkpoint server, the receipt of a checkpoint event from one data repository server causing the selector server to queue data change events until a checkpoint event has been received from each of the data repository servers from which the selector server receives data, after which processing of the queued data change events takes place.

7. A system as claimed in claim 1, wherein the selector server is capable of a cold start in which the cached filtered data is re-created from the data repository server, and a warm start in which the cached filtered data is re-created from the existing cached filter data and a history of data change events which have been published by the data repository server.

8. A system as claimed in claim 7, wherein the history of data change events is held on the selector server.

9. A system as claimed in claim 7, wherein the history of data change events is held on the data repository server.

10. A system as claimed in claim 1, including a subscribing application server which receives filtered data re-published by the selector server and also receives notification of data change events from the selector server, the application server hosting an application which provides information derived from the received filtered data for transmission to a client, and wherein on notification of a data change event from the selector server, updated data in accordance with the change event is transmitted from the application server to the client.

11. A system as claimed in claim 10 wherein the updated data is used to change only that portion of information displayed to a user by a client user interface which is affected by the data change event.

12. A system as claimed in claim 1, wherein a number of analytical engines are provided and a broker framework receives requests for an analysis of data and selects one or more engines to use in carrying out the requested analysis.

13. A data repository server for use in a publish—subscribe system in which data is published from the data repository server to a subscribing client, a subscribing selector server receives data published by the data repository server, filters the published data in accordance with filtering criteria defined on the selector server, and re-publishes the filtered data to the subscribing client, and in which the filtered data is cached on the selector server and is available for querying by the subscribing client; wherein the data repository server is configured to publish data change events, to maintain a history of data change events and to re-transmit a set of data change events which have occurred after a specified point, in response to a request from the selector server.

14. Computer software in the form of machine readable code on a data carrier which when run on data processing apparatus will configure the data processing apparatus as a data repository server for use in a publish—subscribe system in which data is published from the data repository server to a subscribing client, a subscribing selector server receives data published by the data repository server, filters the published data in accordance with filtering criteria defined on the selector server, and re-publishes the filtered data to the subscribing client, and in which the filtered data is cached on the selector server and is available for querying by the subscribing client; wherein the computer software further configures the data repository server to publish data change events, to maintain a history of data change events and to re-transmit a set of data change events which have occurred after a specified point, in response to a request from the selector server.

15. A selector server for use in a system in which data is published from a data repository server to a subscribing client, wherein the selector server is configured as a subscribing selector server to receive data published by the data repository server, to filter the data in accordance with filtering criteria defined on the selector server, to re-publish the filtered data to a subscribing client, and to cache the filtered data so that it is available for querying by the subscribing client.

16. A selector server as claimed in claim 15, being further configured to receive data published by two or more data repository servers.

17. A selector server as claimed in claim 15, being further configured to receive data re-published by at least one preliminary selector server.

18. Computer software in the form of machine readable code on a data carrier which when run on data processing apparatus will configure the data processing apparatus as a selector server for use in a system in which data is published from a data repository server to a subscribing client, wherein the computer software configures the selector server as a subscribing selector server to receive data published by the data repository server, to filter the data in accordance with filtering criteria defined on the selector server, to re-publish the filtered data to a subscribing client, and to cache the filtered data so that it is available for querying by the subscribing client.

19. An application server for use in a publish—subscribe system in which data is published from a data repository server to a subscribing client, a subscribing selector server receives data published by the data repository server, filters the published data in accordance with filtering criteria defined on the selector server, and re-publishes the filtered data to the subscribing client, in which the filtered data is cached on the selector server and is available for querying by the subscribing client; and in which the data repository server is configured to publish data change events, to maintain a history of data change events and to re-transmit a set of data change events which have occurred after a specified point, in response to a request from the selector server;
wherein the application server is configured to receive filtered data re-published by the selector server and also to receive data change events re-published by the selector server, the application server hosting an application which provides information derived from the received filtered data for display to a client, and being further configured so that on notification of a data change event from the selector server, updated data in accordance with the change event is transmitted from the application server to the client.

20. Computer software in the form of machine readable code on a data carrier which when run on data processing apparatus will configure the data processing apparatus as an application server for use in a publish—subscribe system in which data is published from a data repository server to a subscribing client, a subscribing selector server receives data published by the data repository server, filters the published data in accordance with filtering criteria defined on the selector server, and re-publishes the filtered data to the subscribing client, in which the filtered data is cached on the selector server and is available for querying by the subscribing client; and in which the data repository server is configured to publish data change events, to maintain a history of data change events and to re-transmit a set of data change events which have occurred after a specified point, in response to a request from the selector server;
wherein the computer software configures the data processing apparatus to receive filtered data re-published by the selector server and also to receive data change events re-published by the selector server; to host an application which provides information derived from the received filtered data for display to a client; and, on notification of a data change event from the selector server, to transmit updated data in accordance with the change event from the application server to the client.

21. A system of publishing data change events from a plurality of data repository servers to a subscribing client, wherein a subscribing selector server receives data published by the data repository servers and re-publishes the data change events to the subscribing client, and wherein there is provided a checkpoint server which transmits checkpoints to each of the data repository servers at intervals, each data repository server being configured to publish a checkpoint event on receipt of a checkpoint from the checkpoint server, the receipt of a checkpoint event from one data repository server causing the selector server to queue data change events until a corresponding checkpoint event has been received from each of the data repository servers from which the selector server receives data, after which processing of the queued data change events takes place and the data change events are re-published to the subscribing client.

22. A system for analysing data published from a data repository server to a subscribing client, wherein an analytics server provides a plurality of analytics engines which provide calculation based services to the client, there being a broker framework which receives requests for calculations on data and determines which of the analytics engines should be used for a particular request.
